(19) United States
(12) Patent Application Publication
(10) Pub. No.: US 2022/0014352 A1
(43) Pub. Date: Jan. 13, 2022

(54) SMART PROMPTS, AI-BASED DIGITAL REPRESENTATIVE, AND MULTI-OBJECT STEGANOGRAPHIC ENCRYPTION

(71) Applicant: Rearden Ventures, Inc., Salt Lake City, UT (US)

(72) Inventors: Stephen William Shillingford, Salt Lake City, UT (US); Kenneth Lee Saunders, Salt Lake City, UT (US); Samuel Zachary Shillingford, Highland, UT (US)

(21) Appl. No.: 17/374,919

(22) Filed: Jul. 13, 2021

Related U.S. Application Data
(60) Provisional application No. 63/051,052, filed on Jul. 13, 2020.

(51) Int. Cl. H04L 9/06; H04L 9/08; G06F 21/62; G06Q 30/02; G06Q 50/00; G06N 20/00

(52) U.S. Cl. CPC H04L 9/06; H04L 9/0894; G06F 21/6209; H04L 2209/34; G06Q 50/01; G06N 20/00; H04L 2209/16; G06Q 30/0201

(57) ABSTRACT

Systems and methods are described herein to enable the automated and/or user-guided creation, collection, and curating of digital content items that represent a user's experiences, personality, interactions, and legacy. A digital rights trustee may be assigned to control access to the content after the death of the user. A user may create a death file with content items to be handled in a specific (e.g., user-specified) manner after the death of the user. For example, the contents of the death file may be released to a family member or deleted by the system entirely. Content items may be secured or encrypted to allow access via the presentation of steganographically encoded objects. An AI-based digital representative may use a machine learning model to act on behalf of a user to create, share, and post content items to a website or social media platform.

### RELATED APPLICATIONS

The application claims priority to and benefits under 35 U.S.C. § 119(e) to U.S. Provisional Patent Application No. 63/051,052 filed on Jul. 13, 2020, titled “Smart Prompts and AI-Based Digital Representative,” which application is hereby incorporated by reference in its entirety to the extent it is not inconsistent herewith.

### TECHNICAL FIELD

This disclosure generally relates to systems and methods for creating, collecting, sharing, and curating digital content, including photographs, documents, videos, and audio recordings.

### BRIEF DESCRIPTION OF THE DRAWINGS

The written disclosure herein describes illustrative embodiments that are nonlimiting and non-exhaustive. Reference is made to certain of such illustrative embodiments that are depicted in the figures described below.

FIG. 1 illustrates a block diagram of some example functionalities of a digital asset vault system that may be available through a web portal or mobile app, according to one embodiment.

FIG. 2 illustrates a high-level block diagram of a step-by-step process for improved management of digital assets, according to one embodiment.

FIG. 3 illustrates another block diagram of a digital asset vault system identifying some potential functionalities, according to one embodiment.

FIG. 4A illustrates another high-level block diagram of a digital asset vault system with optional export or storage options, according to one embodiment.

FIG. 4B illustrates an example timeline of life events that may each be associated with various digital content items stored within the digital asset vault system, according to various embodiments.

FIG. 5 illustrates an example block diagram of the digital asset vault system integrating with third-party systems for one-time or ongoing content collection and curation, according to one embodiment.

FIG. 6 provides a block diagram of an example of a computing system to perform the systems and methods described herein, according to one embodiment.

FIG. 7 illustrates an example graphical user interface (GUI) for a user to create new stories or navigate to view friends' stories (i.e., other users' stories), according to one embodiment.

FIG. 8 illustrates another view of the GUI for a user to create new stories or navigate to view friends' stories, according to one embodiment.

FIG. 9 illustrates an example of a list view GUI for the user to navigate previously created stories, according to one embodiment.

FIG. 10 illustrates an example of a tiled view GUI for the user to navigate previously created stories, according to one embodiment.

FIG. 11 illustrates an example of a GUI for viewing, editing, or publishing a story created by the user, according to one embodiment.

FIG. 12 illustrates an example of a GUI for editing an existing story, according to one embodiment.

FIG. 13 illustrates an example of a GUI for creating a new story, according to one embodiment.

FIG. 14 illustrates an example of a GUI for managing the access of others to a story created by the user, according to one embodiment.

FIG. 15 illustrates an example GUI for associating previously created moments with a story, according to one embodiment.

FIG. 16 illustrates an example GUI providing a user with examples, ideas, and templates for creating new stories, according to one embodiment.

FIG. 17 illustrates an example GUI for generating a holiday newsletter using a template that allows for the incorporation of previously created stories and/or moments, according to one embodiment.

FIG. 18 illustrates an example of a GUI for creating a new moment content item from scratch or from a template, according to one embodiment.

FIG. 19 illustrates an example of a GUI for creating a new moment content item and uploading and associating various digital content items, according to various embodiments.

FIG. 20 illustrates an example of a GUI for previewing a moment content item prior to publishing, according to one embodiment.

FIG. 21 illustrates an example of a possible home or landing page of a digital asset vault system, according to one embodiment.

FIG. 22 illustrates a block diagram of the various functionalities available through various embodiments of the digital asset vault systems and associated methods described herein.

FIG. 23A illustrates an example block diagram of a system generating smart prompts for a user, according to one embodiment.

FIG. 23B illustrates an example block diagram of a system using a machine learning model to automatically generate and post content to social media platforms, according to one embodiment.

FIG. 24A illustrates an example of a multi-object steganographic encryption system, according to one embodiment.

FIG. 24B illustrates an example of a multi-object steganographic decryption system, according to one embodiment.

FIG. 25 illustrates an example block diagram of a multi-object steganographic access control system, according to one embodiment.

In the following description, numerous specific details are provided for a thorough understanding of the various embodiments disclosed herein. The systems and methods disclosed herein can be practiced without one or more of the specific details, or with other methods, components, materials, etc. In addition, in some cases, well-known structures, materials, or operations may not be shown or described in detail in order to avoid obscuring aspects of the disclosure. Furthermore, the described features, structures, or characteristics may be combined in any suitable manner in one or more alternative embodiments.

### DETAILED DESCRIPTION

This disclosure describes numerous possible features and functionalities that can be incorporated into a digital asset vault system. A digital asset vault system (referred to as simply “system” in many instances) may provide a user-directed and controlled digital asset vault. The digital asset vault allows any member of the system to create, collect, share, delete, control, and curate important information about themselves, their life experience, and their personal histories. The digital asset vault provides the analog of a genetic footprint in that it gives a user the ability to pass on the “nurture elements” of their life history in much the same way genetic material passes on “nature elements” to a user's future generations.

A user can leverage current formats and techniques for creating meaningful, curated content about themselves, their values, their interests, likes, dislikes, motivations, and other things that make up their personalities. In some embodiments, the content is enhanced by systems and methods that support a user's attestations, including systems and methods that utilize augmented and virtual reality. For example, the content may include selected writings from a wide variety of sources (e.g., documents, email, tests, blog posts, tweets, etc.), photos and videos derived from one or more platforms (e.g., smartphone, camera, social networking platform, gaming systems, etc.), as well as other representative input collected via scanning, faxing, optical character recognition or any other means to transform physical artifacts into digital representations.

Examples of such content may also include pictures, videos, messages, etc. from physical devices (e.g., smartphones, laptops, internet of things (IoT) devices, etc.) and web-based platforms (e.g., social networking sites, email services, news sites, etc.). As described herein, the system enables the customization and curation of this content for the purposes of memorializing and sharing with any user-designated social circles (e.g., family, friends, colleagues, etc.) during the user's life and after the user's life in a controlled manner.

In various embodiments, the digital asset vault system is more than a mere aggregation of data stored on various social media and other data storage platforms. The digital asset vault system facilitates, encourages, reminds, and aids the user in curating a custom selection and arrangement of digital content. In various embodiments, a user may link the digital asset vault platform to various websites and sources of digital content. A customized curation interface may facilitate the selection and curation of content from the linked platform(s).

The system may utilize a web, desktop, and/or mobile application to provide users with a personalized setup process. A user may provide personal information during setup that may guide the system in sharing some initial and ongoing organizational templates based on a user's desired preferences, responses to automated system prompts based on a user's preferences, tracked activities, and/or the like. The system may leverage machine-learning techniques to decide the types of content to add to a user's profile and in making template suggestions. In various embodiments, users can initiate a profile, set sharing parameters, and provide federated access to members of that user's social circles (e.g., family, friends, associates, etc.).

In some embodiments, the system may leverage artificial intelligence techniques (e.g., deep learning, neural networks, etc.) and trained machine learning models to analyze the content created, posted, uploaded, liked (e.g., thumbs up or smiley face), disliked (e.g., thumbs down or frowny faced), and/or followed to identify characteristics of the user. A machine learning model may be trained to function as an AI-based digital representative that can act on behalf of the user to like, share, create, and post on websites, blogs, social media platforms, and/or the like.

The system may, for example, utilize natural-language processing to analyze the user's previously created content to match the user's tone, style, attitude, emotion, intelligence, and the like. The AI-based digital representative can post content to social media accounts, like and follow content, respond to online material, reply to comments, and/or otherwise act on behalf of the user.

Initially, the user may review (before or after publication) content created by an AI-based digital representative. The system may analyze changes, additions, or revisions made by the user to improve the accuracy and emulation of the user. In such embodiments, the system may utilize the user feedback as supervised training of the artificial intelligence system to improve the behavior of the AI-based digital representative.

A system may identify a plurality of trending topics, images, news articles, sounds, music, videos, and the like. The system may analyze and monitor the user's manual activities on social media platforms, photo repositories, location tracking databases, content items posted by the user, third-party content that is liked, shared, or saved by the user, and/or other digital activities of the user.

The system may identify an intersection of the trending topics and the digital activities of the user. In non-automatic embodiments, the system may generate content suggestions, such as suggested topics for creating new content, suggested user images for uploading or describing, or third-party content to share and comment on. In automated embodiments, the system may train a machine learning model to automatically generate and post content (e.g., images, videos, sound bites, music, text, or the like) to one or more websites or social media platforms. In some embodiments, revisions or edits to the automatically posted content may be used as feedback to improve the machine learning model.

The system may be hosted in cloud-based infrastructure and secured with a zero-knowledge architecture, where all cryptographic security measures rely on only the user being able to unlock and access their profile. Administrator access may not be allowed, and any breach of the cloud-based servers would likely only provide an attacker with a cryptographic “blob” of information or another unusable data dump. Users may export their entire vault without delay in a portable file format for use on third-party systems. Categories of information aggregated by the system include, by way of example, but not limitation, user-generated free text, multimedia, links to third-party platforms, automated inputs from third-party systems, and any and all physical-to-digital transformation techniques.

Information stored on the system by the user may be protected in an encrypted file format. The user may uniquely control access and/or utilize any of a wide variety of access control and/or other security approaches. In some embodiments, without the access rights granted by the user (or subsequently by those designated as “digital rights trustees” by the user), the information stored on the system is rendered unreadable.

Many embodiments of the systems described herein enable the user to create, collect and curate information about their life history using various multimedia formats including written text, recorded voice, pictures, video, and digitally rendered avatars. A digital rights trustee may not be given access to all digital content. Instead, in the context of the digital asset vault system, a digital rights trustee may have and/or control access to only the curated and selected digital content within the digital asset vault system. Thus, the carefully curated and customized content on the digital asset vault platform remains within the control of the digital rights trustee and can be shared with selected individuals and entities.

Once a user creates an account and goes through the initial onboarding process, the system may automatically, or per user-defined settings, prompt the user at various intervals with questionnaires on certain subjects (for example, early childhood memories, family history, school history, friends, teenage memories, military experience, key influences, favorite movies, books, music, etc.).

In various embodiments, the system may allow users to go at their own pace or select certain topics they would like to cover. In other embodiments, the system may require or prompt a user to follow a predefined, user-selected, or user-defined prompting schedule.

Users may create their own subjects and/or questionnaires that are answered once, at a predefined future date, or periodically per user-defined prompting settings associated with the subjects and/or questionnaires. Users may share their customized subjects and/or questionnaires with specific friends or a broader digital asset vault community. A marketplace associated with the community may allow for monetization by users and/or the operator of the digital asset vault system. In some embodiments, the system may include one or more subjects/questions by default and/or available for purchase.

After users have started to populate their account with information, they may select from a variety of formats (written text, voice recording, video recording, avatar playback, etc.) by which they wish to have specific information available for consumption by those granted access rights.

The system may tag stored information with metadata that will enable all content (words, sound, pictures, video) to be searchable based on keywords. Metadata may be encoded with hypertext links that allow consumers to quickly and easily access additional details on associated information available in the system.

For example, a user may list their five favorite books. A user, or the system, may embed each book with hyperlinks to connect future consumers of the information to Wikipedia pages with more information on the books as well as hyperlinks to e-commerce sites where the book may be purchased. The system may enable the consumer to create a closer connection and/or form a closer bond with the original user who uploaded the information.

In various embodiments, the system may prompt the user to contribute content in various manners. For example, the system may send an email or text message to the user prompting the user to add content. Additionally, or alternatively, the system may prompt the user via an app notification or alert on a mobile device. The system may leverage machine learning and/or other artificial intelligence techniques and approaches to ask questions or prompt the user to submit targeted content based on previously submitted content and/or the user's responses to specific questions.

For example, if the user has previously posted content about their pets, the system may prompt the user to add additional content by suggesting that the user enter the names of the pets and how those names were chosen. If the user has previously posted content about a child, the system may suggest that the user describe the most recent birthday of the child or other life events of the child. In contrast, if the user has not posted content about a child or pet, the system may not prompt the user with respect to these topics and instead focus on what the user is assumed to care most about based on previously uploaded content.

In some embodiments, the system may pose questions that the user answers. The answers to the questions are used to customize the suggestions and prompts made by the system. In other embodiments, the system may analyze the previously uploaded content to identify topics or persons of interest to the user, and base subsequent prompts and suggestions on these identified topics and persons.

In some instances, the system may identify an item, person, or topic of interest. The system may identify other users with similar tastes and identify additional potentially interesting items, persons, or topics of interest. The system may suggest or prompt the user to create or add content relating to these potentially interesting items, persons, or topics of interest.

As an example, the system may determine that a user likes hunting based on previously uploaded content. Based on an analysis of other user content, the system may determine that users who like hunting are likely to also enjoy fishing. Accordingly, the system may prompt the user to upload photos of a recent fishing trip, even though the user may not have explicitly mentioned fishing in previously created content. As another example, the system may determine that a user is likely to be interested in arts and crafts based on content “liked” or “followed” on social media websites. The system may prompt the user to describe a recent or planned project.

The system may identify future plans described in created content, such as a future project, planned trip, upcoming event, etc. The system may determine a time period associated with the future plans (e.g., a future date after which the project should be completed, the trip should be taken, or the upcoming event should have passed). The system may prompt the user after the time period has passed to describe how it went, upload videos, upload photos, etc.

The system may allow the user to grant access rights to their stored information to certain individuals, such as immediate family members. The system may also allow a user to determine the timing on when such access will be permitted. As previously described, the system allows the user to designate certain individuals with authority to take over the control of future access rights to their information. Information on individuals granted access rights and/or those designated as a digital rights trustees may be stored to the blockchain to make the access rights immutable and incorruptible.

The system includes tools to enable users to import information (words, pictures, video, sound) previously uploaded to other social media platforms such as Facebook®, Twitter®, LinkedIn®, YouTube®, or Instagram®. In various embodiments, users have the absolute ownership of their information stored in the digital asset vault system. Without the consent of the user or the digital rights trustee, the information is not shared with anyone else.

In various embodiments, the users may remove their information from the system and/or export their information in various formats. In various embodiments, the digital rights trustee cannot remove the information from the system. In some embodiments, a user may store a sample of their DNA in the system in addition to any other information they may choose to upload. In some embodiments, if the user chooses to store their DNA in the system, the stored DNA may be used to confirm ancestry and grant access rights in cases where no access rights or digital rights trustees remain associated with the account.

In various examples, the system may include hardware, software, firmware, and/or combinations thereof to implement modules, systems, and subsystems—which terms are used interchangeably, unless context dictates otherwise. The system may provide examples, templates, ideas, and/or questions intended to prompt ideas to help users create story content items (or simply “stories”), moment content items (or simply “moments”), and/or the like. Templates and other content may be created by operators of the system, third-party companies, and/or other users. In some instances, templates and other content may be freely available, available only to subscribers, and/or available in a marketplace for user-set fees or free.

The system may, for example, include templates for stories and/or moments for milestones (e.g., births, marriage, religious ceremonies, deaths, new homes, birthdays, etc.). The system may periodically or continually ask a user questions to get to know them better and make more meaningful suggestions and/or template recommendations. The system may, in some embodiments, follow other social media activities of users to identify events that should be included in the system. The system may try to ask questions relevant to their personal experiences and life stages. For example, the system may ask about the moon landing to older users but not to younger users.

In various embodiments, a user may create stories, moments, and/or other content and then invite family, friends, or others to edit or supplement the content they have created. In some embodiments, a user may choose to make some content public, some content visible to friends and family, some content available to only close family, or some content visible to a single individual. In still other instances, it may be desirable to maintain some content completely private until after death—at which time it may be desirable to share such content. For example, personal journals may be kept private during life but shared after death. Accordingly, the system may allow a user to create a death file with specific instructions for how the contents of the death file should be handled after the user's death.

In one example, the system may utilize steganographic techniques to encode a digital key, or portions of a digital key, that can be used to unlock or otherwise access a user's death file (or other content) after the user's death. For example, a user may encode an encryption key, password, username, login credentials, or other access information within another file, message, image, or video (steganographic medium). Upon the death of the user, the steganographic medium may be used to access the user's death file or other content left behind.

In one specific embodiment, a user creates and/or uploads digital content to a platform for storage, organization, etc. (as described in any of the various embodiments herein). The user may encrypt or otherwise secure the digital content to prevent unauthorized access by other individuals. The user may desire that the created and uploaded content be made accessible after the user's death to specific individuals. For example, a mother or father (or grandfather, grandmother, uncle, aunt, etc.) may desire to make the stored digital content available to their posterity after the user's death. The system may generate a steganographic key that the user can share with a member of their posterity (e.g., a child or grandchild). The child or grandchild may be instructed to present the steganographic key to the system after the user's death to obtain access to the deceased user's digital content.

In some embodiments, the system may prevent the use of the steganographic key for a predetermined amount of time after the creation of the steganographic key or after the death of the user. In some embodiments, the system may leverage smart contracts or other blockchain-based technologies to prevent usage of the steganographic key until after the death of the user or until after a predetermined amount of time after the death of the user. In one example, the system can be used to generate multiple steganographic keys, any one of which may be used by a keyholder to access the user's digital content.

In other examples, the system may be used to generate multiple steganographic keys, all of which are required to access the user's digital content. Thus, for example, the user may create three steganographic images that are encoded with decryption information for accessing the user's digital content stored in the system. The user may distribute each steganographic image to a different child or grandchild. Upon the user's death, the three steganographic images may be used together to access the user's stored digital content. In some examples, no single steganographic image may be used by itself to access the user's digital content. The user may trust that all three of the children or grandchildren will not betray his or her trust by, together, accessing the user's digital content prior to the user's death (or until after a predetermined time period after the user's death).

In any of the embodiments described herein, other types of steganographic media may be utilized instead of, or in addition to, steganographic images. For example, steganographically encoded media such as images, audio files, videos, text, messages (e.g., emails, SMS messages, MMS messages, etc.), or the like. The system may receive the steganographic media by file upload, via a camera, via a microphone input, via text input, or the like.

A digital asset vault system may include a processor and a computer-readable medium with instructions stored thereon that, when executed by the processor, cause the processor to implement a set of modules or subsystems. The system may include server-based software, client-side software, mobile apps, hardware components, specific custom hardware designed for creating and curating content, or any combination thereof. In various embodiments, a profile module or onboarding subsystem may obtain personal data from a user to create a personal account for the user.

The user may have complete control over who else may see and who else has access to created content. For example, a circle management module may enable the user to connect to other users of the digital asset vault system and create connected-user groups (e.g., friends, family, work colleagues, hobbyists, etc.). In some embodiments, the system may automatically make groups or unions of existing groups that might facilitate content sharing, collaboration, and discussion.

A content curation module may provide a graphical user interface to facilitate user uploads of digital content items, such as digital photographs, audio recordings, video recordings, electronic documents, scanned documents, images, graphics, and text (e.g., types, dictated, or the like). An invitation module may receive a request from the user to invite other users (e.g., friends) to edit digital content items and/or other content created by the user. The invitation module may forward or transmit the invitation to view and/or edit the user-created content. A template module may suggest templates to users, receive user-created templates for inclusion in a library of templates, and/or manage the types of templates displayed to different users to provide relevant suggestions.

As previously described, in some embodiments, a death file module may receive digital content items from the user identified as death-file content items. The death file module may receive instructions from the user specifying actions to be taken with respect to the death-file content items following the death of the user. The system may confirm or receive confirmation that the user has died and then implement the actions specified by the user with respect to the death-file content items. In some embodiments, the death file may be cryptographically encrypted as part of a blockchain-based smart contract that provides for the release of a decryption key for decrypting the death-file content items only after the death of the user and as part of the terms of the smart contract.

As previously described, the system may allow for digital rights trustees to manage access to content after a user has become incapacitated and/or passed away. A digital trustee module may manage the creation and editing of digital rights trustees. The digital trustee module may prompt the user to identify an entity to be the digital rights trustee. The user may specify a set of access rights to be granted to the identified digital rights trustee with respect to the user's content stored within the digital asset vault system. Furthermore, the user may specify a triggering event that will lead to the assignment of the specified set of privileges to the digital rights trustee. Once the defined event has occurred, the digital rights trustee may be granted the specified rights and privileges. A questionnaire module may manage questions asked of a user to improve recommendations and/or prompt ideas. In some embodiments, the questionnaire module may create custom or semi-custom content items based on responses to questions. The questionnaire module may suggest that the user share or publish the created content items.

In some embodiments, a marketplace for templates may allow a user to exchange, give away, and/or earn money for creating, distributing, sharing, and/or selling templates. An open system in which users may create templates may encourage innovation and/or community collaboration. Moment and story creation modules and/or subsystems may facilitate the creation, editing, and sharing of user-created moments and stories. The moment and story creation modules and/or subsystems may facilitate the association of uploaded digital content items (e.g., photos, videos, etc.). Additionally, moments that are generally shorter and simpler than stories may be associated with stories.

For example, a story may cover a relatively long time period during which a user may have created many relevant or related moments. The user may decide to associate some or all of these moments with the story. The association may simply constitute a link to the related content. Alternatively, the associated moments may be explicitly duplicated within the story or moved into the context of the story.

In one specific example, a digital asset vault system enables a user to create, upload, store, and share a plurality of stories relating to, for example, various life events. The user may also create, upload, store, and selectively share various moments (e.g., moment content items) throughout the year. During a particular holiday season or life event specific to the user, the system may make an additional graphical user interface available to allow for the creation of special content items.

For instance, a holiday season module or subsystem may allow a user to select a holiday template, such as a holiday card or holiday newsletter, and then incorporate the previously created moments and/or stories into the holiday template. For example, a holiday newsletter may be quickly created that includes a handful of moment content items that summarize the year in a suitable manner for a holiday newsletter.

In many embodiments, the system may include one or more processors, memory, and a computer-readable medium with instructions stored thereon for implementation by the processor. The system may include a multi-object steganographic encryption and/or decryption subsystem to receive and encrypt a user content item using an encryption key. The encrypted content item can be stored or returned to the user. The system may generate a plurality of encryption key components that can later be used to reconstruct the encryption key.

For example, encryption key components can be generated using any of a wide variety of mathematical functions or operations. For example, a first encryption key component may be a random or arbitrary number and a second encryption key component may be generated via a Boolean logic operation, such as an XOR operation of the encryption key and the random or arbitrary number. As appreciated by those of skill in the art, any number of additional or alternative approaches may be used to split or divide the encryption key into a plurality of encryption key components.

In some embodiments, any two encryption key components may be used to reconstruct the encryption key. In other embodiments, a fixed number (e.g., three, four, five, etc.) of encryption key components are required to reconstruct the encryption key. I still other embodiments, all the encryption key components are required to reconstruct the encryption key.

The system may encode each of the encryption key components within a steganographic object. Each steganographic object may be encoded with one or more encryption key components. Examples of suitable steganographic objects include images, documents, data files, audio files, video files, and/or various multimedia file types. The system may encode the encryption key components within random or arbitrarily selected files, or within specific files provided by a user for that purpose. For example, a user may upload an image or images to be used as the basis for generating the steganographic objects encoded with the encryption key components.

The encrypted content item may be subsequently decrypted using a multi-object steganographic decryption system. The multi-object steganographic decryption system may receive an encrypted content item (e.g., via user upload or via a request to access an encrypted content item in a data store). The user may upload a plurality of steganographic objects encoded with the encryption key components. The system may extract the encryption key components from the received steganographic objects and reconstruct the encryption key using the extracted encryption key components.

The system may then decrypt or otherwise grant access to the content item using the extracted encryption key. The decrypted content item can be delivered or otherwise made available to the user or users presenting the steganographic objects. The user content item to be encrypted and/or decrypted may be, for example, an image, a data file, a multimedia file, a blog, a journal, a video, or the like.

In some embodiments, the multi-object steganographic encryption subsystem generates at least three encryption key components and encodes them within at least three steganographic objects. In some instances, the multi-object steganographic encryption subsystem may generate a requested number of steganographic objects and a corresponding number of encryption key components.

In some instances, instead of encrypting and decrypting content items, the system may control access to content within a secure data storage using steganographic techniques. For example, one or more users may present a plurality of steganographic objects (e.g., via a client computing device) to the system to access a secure content item. In some instances, the users may specify the specific content item within the secure data store to which they want access. In other instances, the uploaded steganographic objects may include an identifier (encoded or otherwise) that identifies the content item within the data storage.

Each of the steganographic objects may be encoded with an access credential component. The access credential components of two, three, or all of the steganographic objects can be extracted and combined to obtain access to the secured content item. In some instances, the system may require multiple access credential components before granting access to the secured content item. In other embodiments, the system may calculate a complete access credential by combining or calculating a function of multiple access credential components. The system may grant access to the secure content item stored in a secure data storage upon successful validation of at least two access credential components. Otherwise, the system may deny access to the secure content item upon failure to validate at least two access credential components.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. In particular, an “embodiment” may be a system, an article of manufacture, such as a computer-readable storage medium, a method, and/or a product of a process.

The phrases “connected to” and “in communication with” refer to any form of interaction between two or more components, including mechanical, electrical, magnetic, and electromagnetic interaction. Two components may be connected to each other even though they are not in direct contact with each other and even though there may be intermediary devices between the two components.

Some of the infrastructure that can be used with embodiments disclosed herein is already available, such as general-purpose computers, computer programming tools and techniques, digital storage media, and communications networks. A computer may include a processor such as a microprocessor, microcontroller, logic circuitry, or the like. The processor may include a special purpose processing device such as an ASIC, PAL, PLA, PLD, Field Programmable Gate Array, or another customized or programmable device. The computer may also include a computer-readable storage device such as non-volatile memory, static RAM, dynamic RAM, ROM, CD-ROM, disk, tape, magnetic, optical, flash memory, or another computer-readable storage medium.

Suitable networks for configuration and/or use as described herein include one or more local area networks, wide area networks, metropolitan area networks, and/or “Internet” or internet protocol (IP) networks, such as the World Wide Web, a private Internet, a secure Internet, a value-added network, a virtual private network, an extranet, an intranet, or even standalone machines which communicate with other machines by physical transport of media. In particular, a suitable network may be formed from parts or entireties of two or more other networks, including networks using disparate hardware and network communication technologies. A network may incorporate landlines, wireless communication, and combinations thereof.

The network may include communications or networking software, such as software available from Novell, Microsoft, Artisoft, and other vendors, and may operate using TCP/IP, SPX, IPX, and other protocols over twisted pair, coaxial, or optical fiber cables, telephone lines, satellites, microwave relays, modulated AC power lines, physical media transfer, and/or other data transmission “wires” known to those of skill in the art. The network may encompass smaller networks and/or be connectable to other networks through a gateway or similar mechanism.

Various input devices and/or output devices may be utilized in conjunction with the presently described systems and methods. Exemplary input devices include, but are not limited to, virtual reality input devices, augmented reality input devices, a keyboard, mouse, touch screen, light pen, tablet, microphone, sensor, or other hardware with accompanying firmware and/or software. Exemplary output devices include, but are not limited to, a monitor or other display, audio outputs, virtual reality interfaces, augmented reality interfaces, printer, switch, signal line, or other hardware with accompanying firmware and/or software.

Some specific embodiments of the disclosure may be further understood by reference to the drawings, wherein like parts are designated by like numerals throughout. It will be readily understood that the components of the disclosed embodiments, as generally described and illustrated in the figures herein, could be arranged and designed in a wide variety of different configurations. Thus, the following detailed description of the embodiments of the systems and methods of the disclosure is not intended to limit the scope of the disclosure, as claimed, but is merely representative of possible embodiments of the disclosure. In addition, the steps of a method do not necessarily need to be executed in any specific order, or even sequentially, nor need the steps be executed only once unless otherwise specified.

Aspects of certain embodiments described herein may be implemented as software modules or components. As used herein, a software module or component may include any type of computer instruction or computer-executable code located within or on a computer-readable storage medium. A software module may, for instance, comprise one or more physical or logical blocks of computer instructions, which may be organized as a routine, program, object, component, data structure, etc., that performs one or more tasks or implements particular abstract data types.

In certain embodiments, a particular software module may comprise disparate instructions stored in different locations of a computer-readable storage medium, which together implement the described functionality of the module. Indeed, a module may comprise a single instruction or many instructions, and may be distributed over several different code segments, among different programs, and across several computer-readable storage media. Some embodiments may be practiced in a distributed computing environment where tasks are performed by a remote processing device linked through a communications network. In a distributed computing environment, software modules may be located in local and/or remote computer-readable storage media. In addition, data being tied or rendered together in a database record may be resident in the same computer-readable storage medium, or across several computer-readable storage media, and may be linked together in fields of a record in a database across a network.

The software modules described herein tangibly embody a program, functions, and/or instructions that are executable by a computer(s) to perform tasks as described herein. Suitable software, as applicable, may be provided using the teachings presented herein and programming languages and tools, such as XML, Java, Pascal, C++, C, database languages, APIs, SDKs, assembly, firmware, microcode, and/or other languages and tools. Additionally, software, firmware, and hardware may be interchangeably used to implement a given function. Software modules and modules described in the context of a computer-readable storage medium may be implemented in hardware, firmware, software, and/or combinations thereof, as appreciated by one of skill in the art.

In some cases, well-known features, structures, or operations are not shown or described in detail. Furthermore, the described features, structures, or operations may be combined in any suitable manner in one or more embodiments. It will also be readily understood that the components of the embodiments as generally described and illustrated in the figures herein could be arranged and designed in a wide variety of different configurations.

In the following description, numerous details are provided to give a thorough understanding of various embodiments; however, the embodiments disclosed herein can be practiced without one or more of the specific details, or with other methods, components, materials, etc. In other instances, well-known structures, materials, or operations are not shown or described in detail to avoid obscuring aspects of this disclosure.

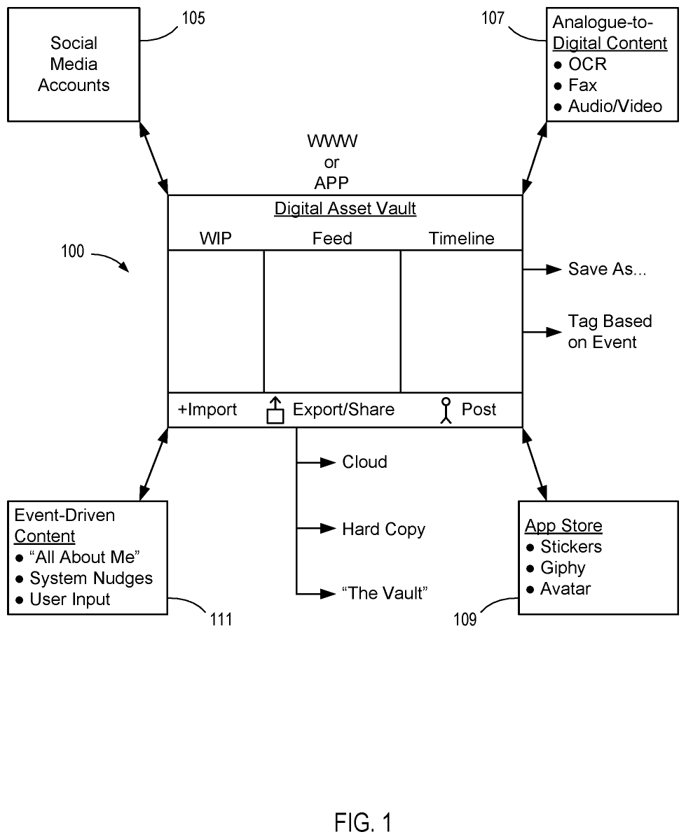

FIG. 1 illustrates an example of a graphical user interface (GUI) 100 of a digital asset vault system that may utilize cloud storage, hard copy versions, and/or digital “vault” storage systems. Various social media accounts 105 and other digital repositories of media may be linked to the system. Event-driven content 111 may include an “all about me” section of personal profile information, provide automatic system nudges, and/or be responsive to user inputs. An analog-to-digital content subsystem 107 may facilitate optical character recognition (OCR) of hard copy media. An application store or marketplace 109 may enable selective access to additional free materials, user-created content, subscription-based content, content for purchase, etc.

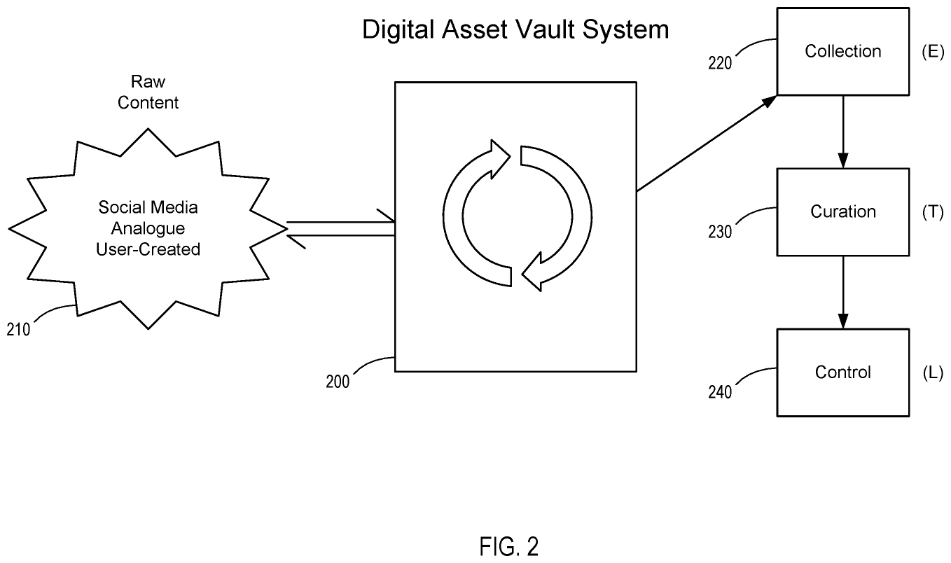

FIG. 2 illustrates a high-level block diagram of a step-by-step process for improved management of digital assets, according to one embodiment. A digital asset vault system 200 may import raw content 210 from existing or abandoned social media content. The digital asset vault system 200 may guide the user through a process of collection 220 and curation 230 of the digital content. A control subsystem 240 or module allows a user to have complete control of current and future access controls, including future access control through a human or computer-enabled digital rights trustee.

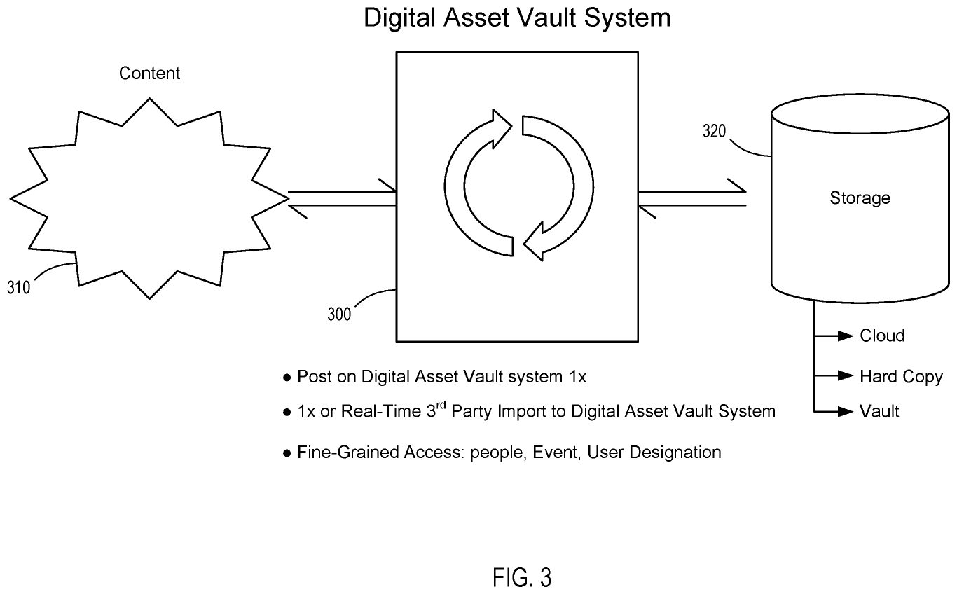

FIG. 3 illustrates another block diagram of a digital asset vault system 300 that receives content 310 through a rough, medium, or fine-grained import process for eventual safekeeping within storage 320. The storage 320 may, for example, comprise cloud storage, hard copy storage, or vault storage. Content created within the digital asset vault system 300 may be automatically sent to multiple other online sites. For example, a digital asset vault content item 310 may be selectively or automatically uploaded to one or more social media accounts, backup storage locations, and/or digital displays, or sent via text messages, emails, and/or other online or electronic communication media.

In some embodiments, the system may leverage artificial intelligence techniques (e.g., deep learning, neural networks, etc.) to analyze the content created, posted, uploaded, liked, disliked, followed, etc., to identify characteristics of the user. The system may further identify dialects, accents, and/or idiosyncrasies unique to the user based on existing user-created content. The system may assimilate this information to develop an AI-based digital representative that can act on behalf of the user.

The system may, for example, utilize natural-language processing to analyze the user's previously created content to match the user's tone, style, attitude, emotion, intelligence, and the like. The AI-based digital representative can post content to social media accounts, like and follow content, respond to online material, reply to comments, and/or otherwise act on behalf of the user.

Initially, the user may review (before or after publication) content created by an AI-based digital representative. The system may analyze changes, additions, or revisions made by the user to improve the accuracy and emulation of the user. In such embodiments, the system may utilize the user feedback as supervised training of the artificial intelligence system to improve the behavior of the AI-based digital representative.

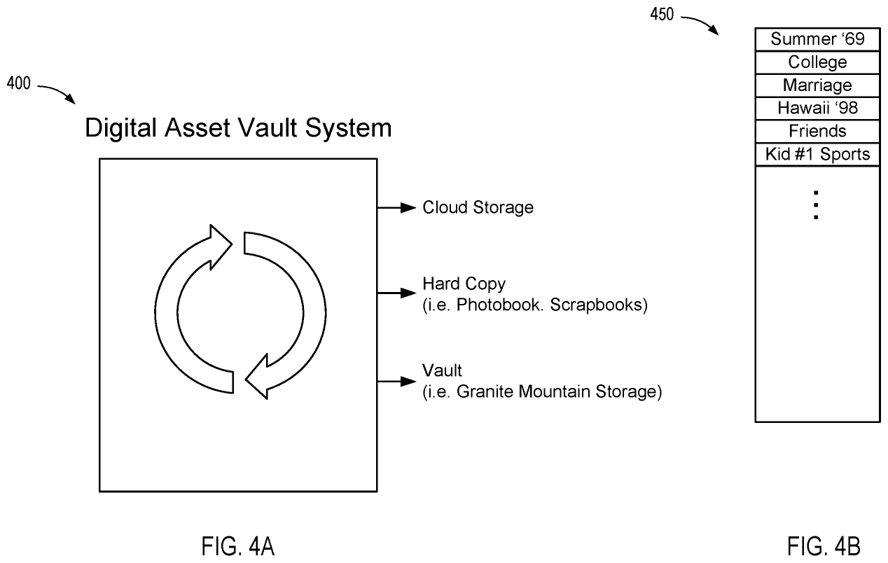

FIG. 4A illustrates a block diagram of one possible layout of a digital asset vault system 400 for a user, according to one embodiment. The content created, curated, modified, collected, or otherwise provided to the digital asset vault system 400 under an automated or user-guided process may be stored in the cloud, in hard copy format (e.g., photobooks, scrapbooks, books, prints, etc.) and/or archived in a digital and/or hardcopy format within a vault (e.g., a physically secure bank vault, a granite mountain storage, within a fireproof safe, etc.).

FIG. 4B illustrates an example timeline 450 of life events that may each be associated with various digital content items stored within the digital asset vault system 400 in FIG. 4A, according to various embodiments.

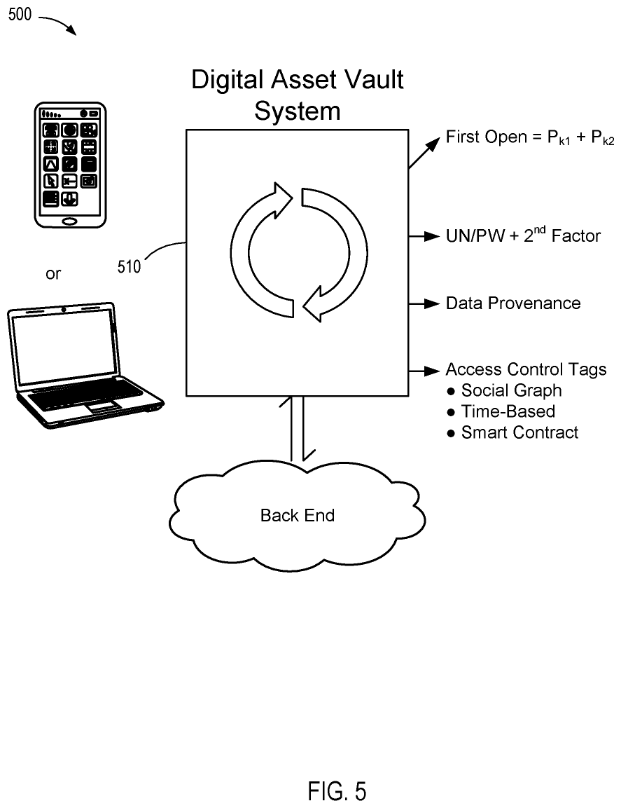

FIG. 5 illustrates an example block diagram 500 of a digital asset vault system 510 integrating with third-party systems for one-time or ongoing content collection and curation, according to various embodiments. As illustrated, various authentication methods may be used to ensure immediate and future security.

Access control tags may provide social graphs, time-based actions and visualizations, and/or smart contract-based transactions. In various embodiments, the infrastructure and underlying web-based or app-based software may be stored locally, remotely, and/or in the cloud. In some embodiments, users may have discretion as to how specific data is stored and/or distributed. In various embodiments, data storage and access may be implemented and/or modified based on the citizenship and/or country of residence to comply with applicable security, health data, personal data, financial data, and privacy laws, and/or other applicable industry norms, regulations, rules, and laws.

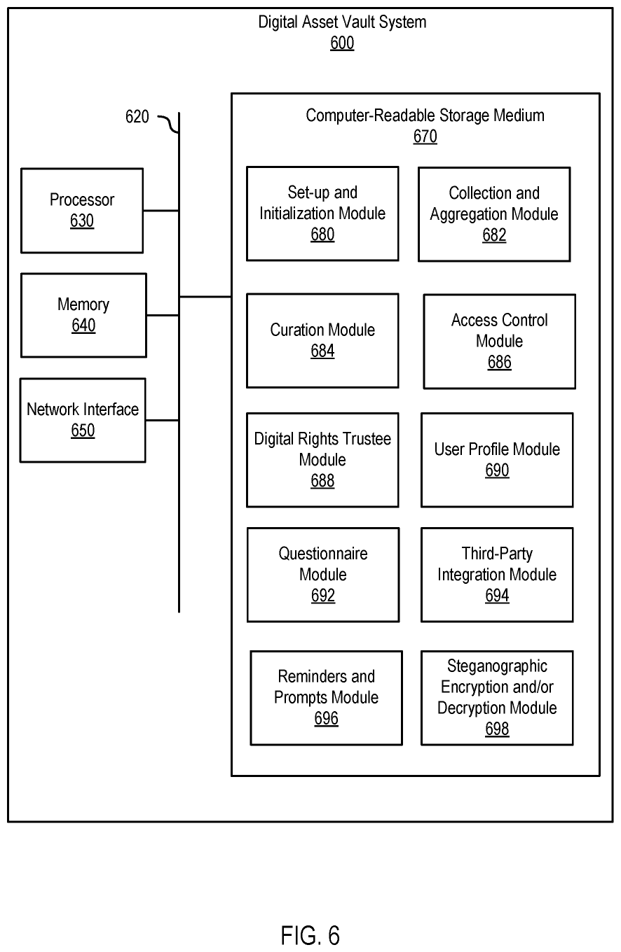

FIG. 6 provides a block diagram of an example of a digital asset vault system 600 with a processor 630 and memory 640 in communication with a network interface 650 and a computer-readable storage medium 670 via a bus 620. The computer-readable storage medium 670 may include a plurality of modules 680-698 that may, as illustrated, be implemented as software modules that interact via network interface 650 and/or via processor 630 with external hardware. In other embodiments, one or more of the modules 680-698 may be implemented in hardware, firmware, software, and/or combinations thereof.

A setup and initialization module 680 may facilitate the initial setup of a user by collecting personal information and/or identifying what additional modules and subsystems may be useful for a full integration into the system 600. A curation module 684 may facilitate creating, adding, and editing content added to the system 600. The curation module 684 may, in some embodiments, be divided into submodules or subsystems to handle specific types of content items. For example, the curation module 684 may comprise a moment creation module, story creation module, and/or associated template management, creation, and recommendation modules or subsystems.

A digital rights trustee module 688 may allow for digital rights trustees to manage access to content after a user has become incapacitated and/or passed away. The digital trustee module 688 may manage the creation and editing of digital rights trustees. The digital trustee module 688 may prompt the user to identify an entity to be the digital rights trustee. The user may specify a set of access rights to be granted to the identified digital rights trustee with respect to the user's content stored within the digital asset vault system 600. Furthermore, the user may specify a triggering event that will lead to the assignment of the specified set of privileges to the digital rights trustee. Once the defined event has occurred, the digital rights trustee may be granted the specified rights and privileges.

A questionnaire module 692 may manage questions asked of the user to improve recommendations and/or prompt ideas. In some embodiments, the questionnaire module 692 may create custom or semi-custom content items based on responses to questions. The questionnaire module 692 may suggest that the user share or publish the created content items.

A reminders and prompts module 696 may provide periodic reminders or nudges to encourage the habit of journaling or other content creation on a regular basis. In some embodiments, the reminders and prompts module 696 may leverage machine learning and/or other artificial intelligence techniques and approaches to ask questions or prompt the user to submit targeted content based on previously submitted content and/or the user's responses to specific questions, as described herein. In some embodiments, the reminders and prompts module 696 may pose questions that the user answers. The answers to the questions are used to customize the suggestions and prompts made by the system 600.

In some embodiments, the digital asset vault system 600 (or another stand-alone system) may include a steganographic encryption and/or decryption module 698 that facilitates encryption and/or decryption of content items using steganographic techniques. Specifically, the steganographic encryption and/or decryption module 698 may implement a multi-object steganographic encryption approach in which the encryption key used to encrypt a content item is divided or split into multiple encryption key components. The encryption key components may be steganographically encoded within steganographic objects. The steganographic objects may be distributed to remote locations and/or to different users. The encryption key can be reconstructed by the presentation of a minimum number of steganographic objects (e.g., two or more, three or more, or all the steganographic objects). The reconstructed encryption key can be used to decrypt the encrypted content item.

Collection and aggregation module 682 may integrate with third-party databases and/or websites to collect, curate, format, and aggregate content created by the user in many prior locations. An access control module 686 may manage access to user-created content. For example, a user may set varying permissions and grant varying access rights to different friends and family members (other users). A user profile module 690 may facilitate updates and modifications to various user profile settings, such as password changes. A third-party integration module 694 may facilitate continuous integration and interoperability with third-party social media networks to help with duplicate posting and/or content transfers.

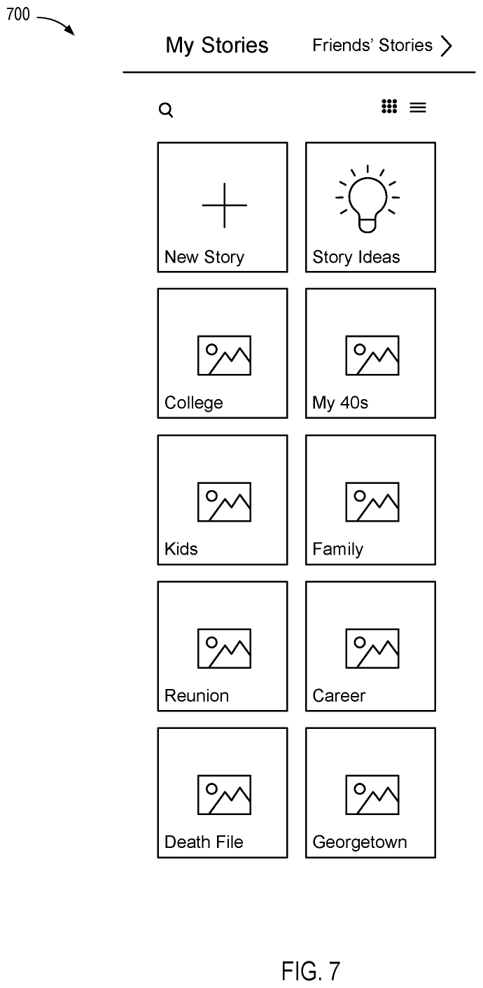

FIG. 7 illustrates an example GUI 700 for a user to create new stories or navigate to view friends' stories (i.e., other users' stories), according to one embodiment. FIG. 7 also lists a number of templates and ideas to help get a user started with a story. Examples, templates, and ideas for stories may include those relating to college, kids, reunions, specific ages, family members, families in general, careers, bosses, co-workers, and/or specific locations.

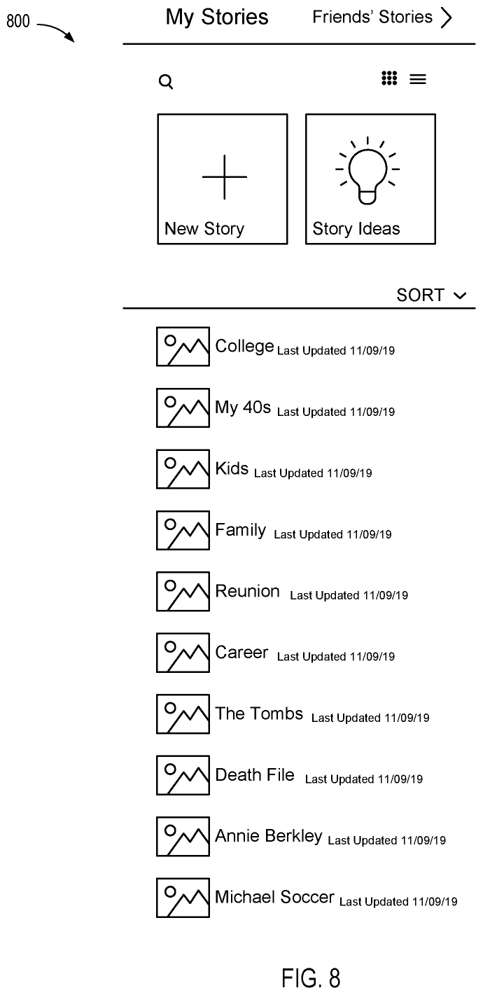

FIG. 8 illustrates another example GUI 800, similar to and related to the GUI 700 in FIG. 7, according to one embodiment. The user may prefer tiled or list views of the GUI 800 depending on the device a user is using (e.g., a cell phone as compared to a laptop). In other instances, list and tile views may be preferred depending on the number of templates, examples, and ideas listed in a given GUI.

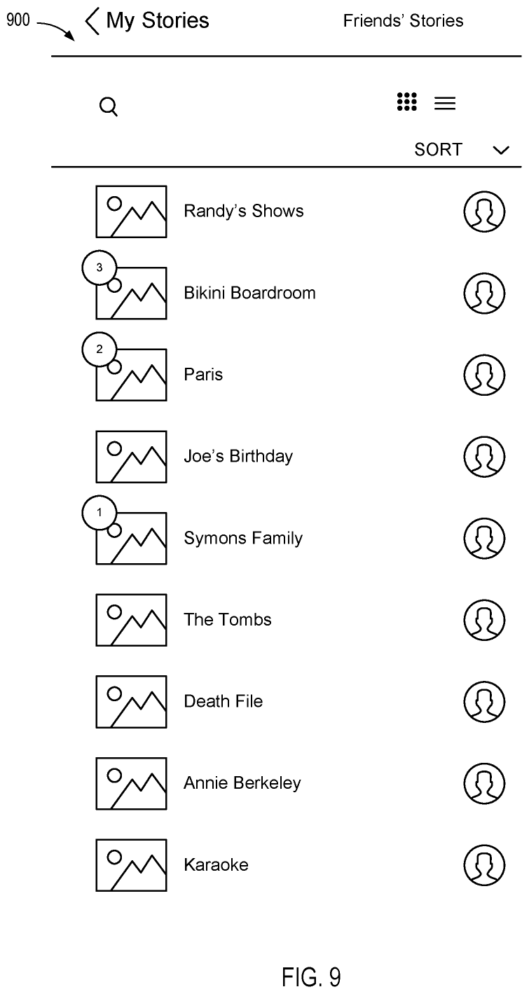

FIG. 9 illustrates an example of a list view GUI 900 for the user to navigate previously created stories, according to one embodiment. The user may select a specific story to view it, edit it, review it, make changes to sharing preferences, or the like. Sort and/or filter functions may allow the user to quickly find a particular story. As in other embodiments, tiled and list views may be available to suit the particular preferences of each user.

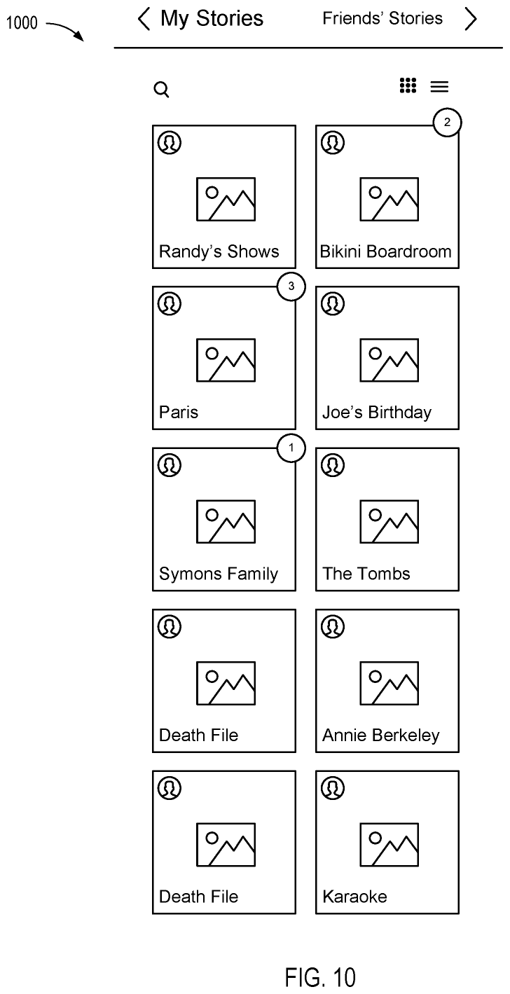

FIG. 10 illustrates an example of a tiled view GUI 1000 for the user to navigate previously created stories, as described in conjunction with FIG. 9 and according to various embodiments.

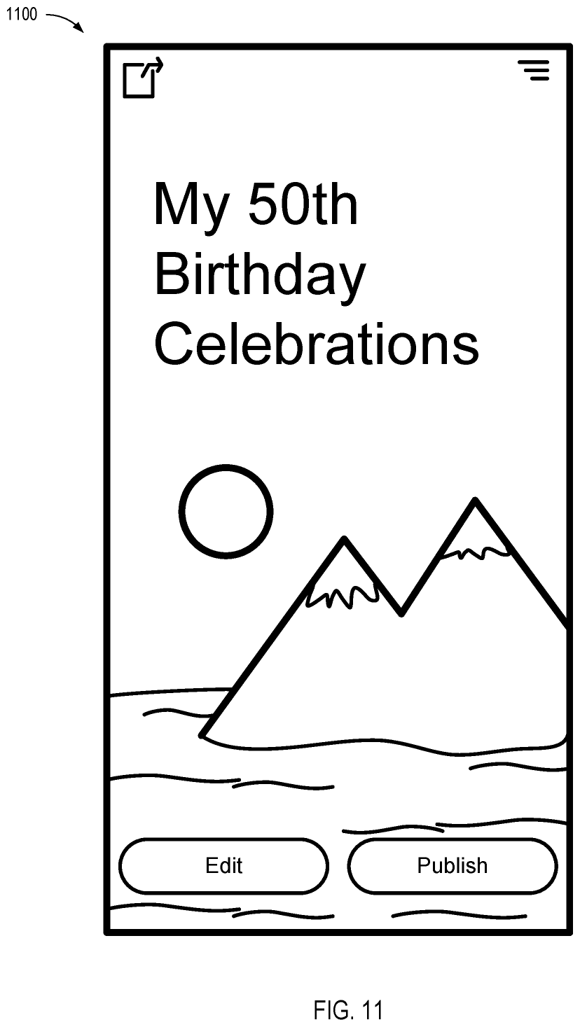

FIG. 11 illustrates an example of a GUI 1100 for viewing, editing, or publishing a specific story created by a user, according to one embodiment. The user may edit the title, the layout of the cover page, the imagery on the cover page, and/or other aspects of the story. Edit and publish buttons are self-explanatory and easily accessible to a user.

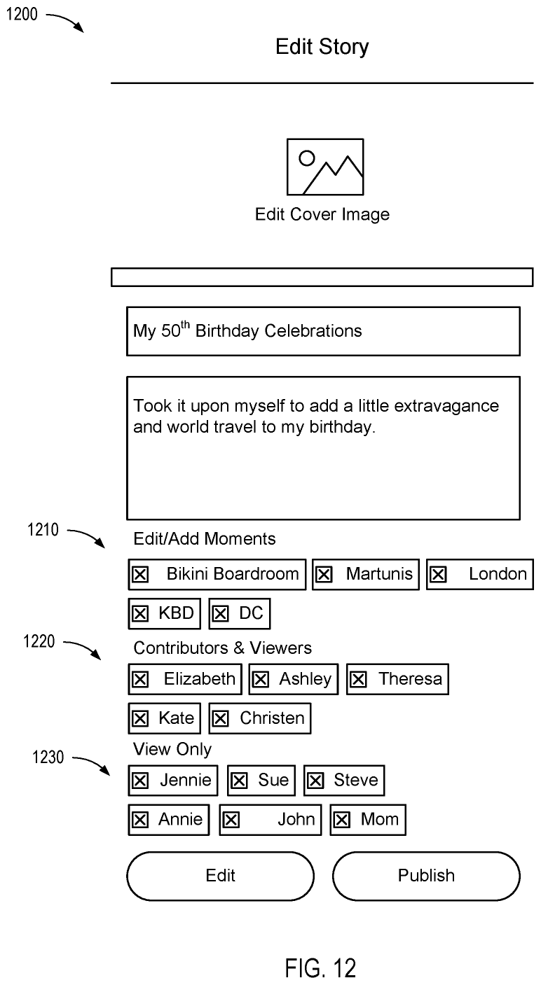

FIG. 12 illustrates an example of a detailed GUI 1200 for editing an example “My 50^{th} Birthday Celebrations” story, according to one embodiment. As illustrated, titles and captions may be easily modified. Additionally, there are options to add or associate moments 1210 with the story. Access privileges of friends and family can be adjusted to allow some of them to contribute and view 1220 and others to view only 1230.

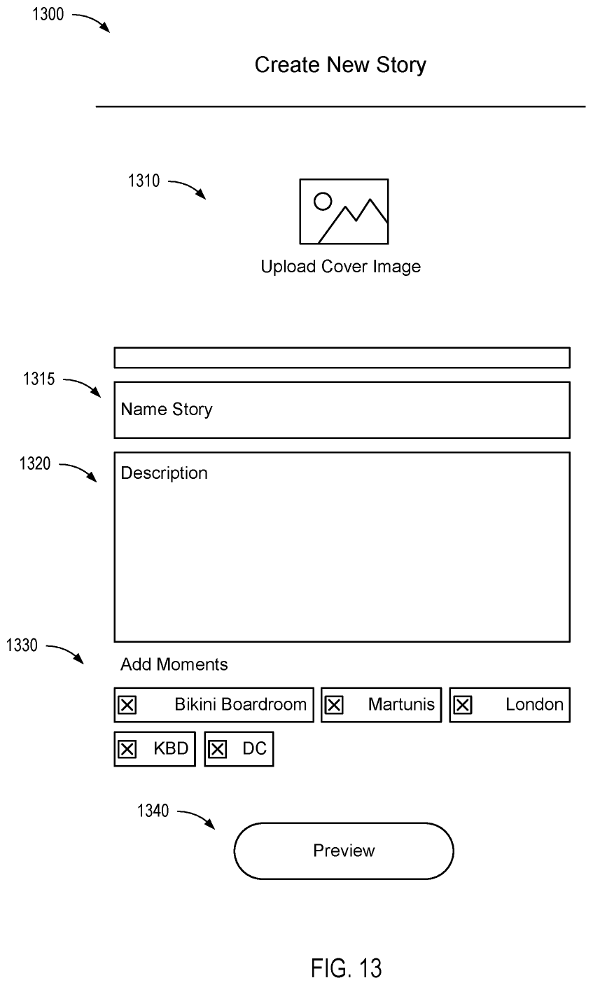

FIG. 13 illustrates an example of a GUI 1300 for creating a new story, according to one embodiment. Artwork, graphics, or photos may be uploaded as a cover image 1310. The user may provide a name 1315 for the story and provide a text description 1320. Moments 1330 may be added to the story and, once the story is completed, the user may preview 1340 the story prior to publishing.

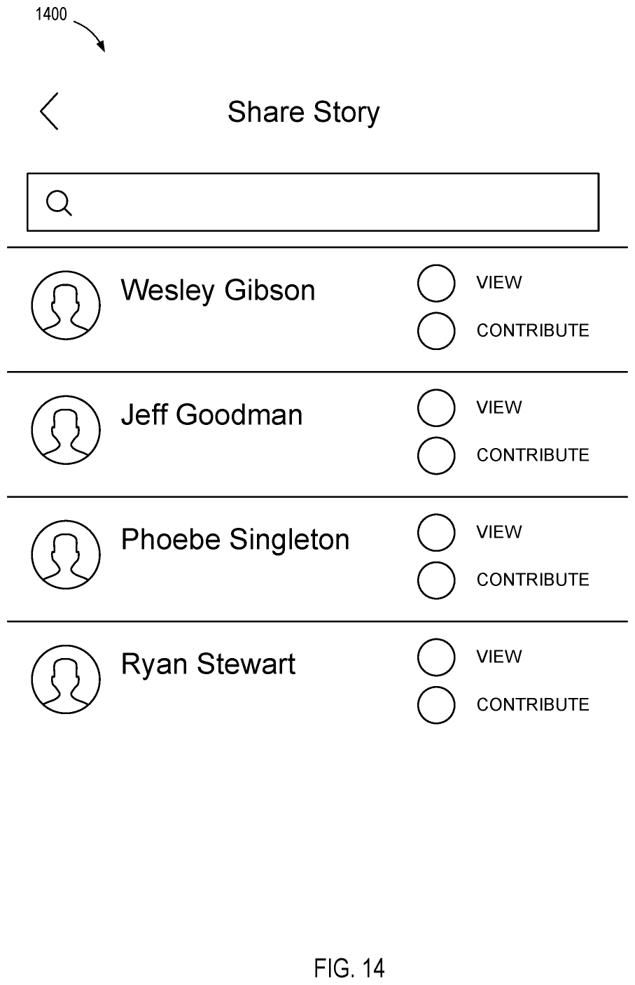

FIG. 14 illustrates an example of a GUI 1400 for managing the access of others to a story created by the user, according to one embodiment. Each of the four listed users may be granted no access, view-only access, and/or approval to contribute to the story.

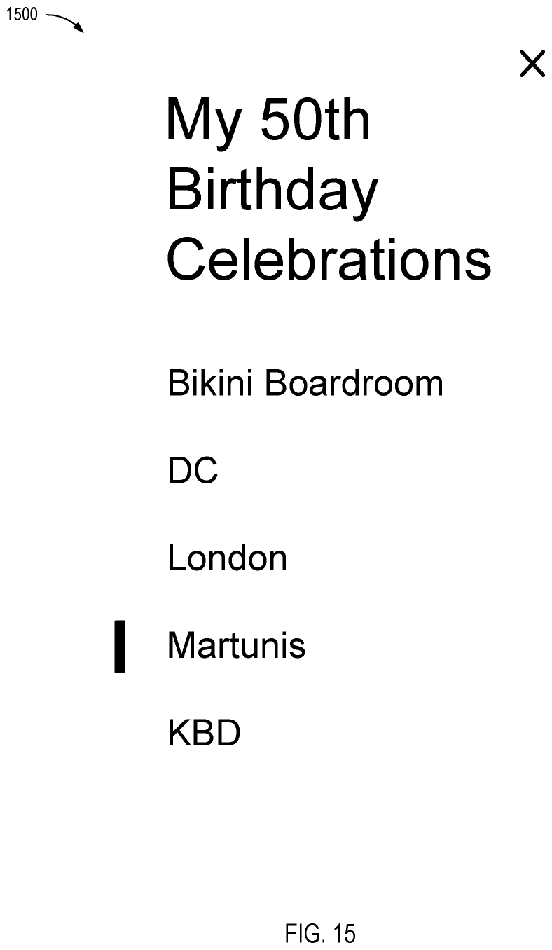

FIG. 15 illustrates an example GUI 1500 showing a specific example of a story as a work in progress with a moment being selected for association therewith.

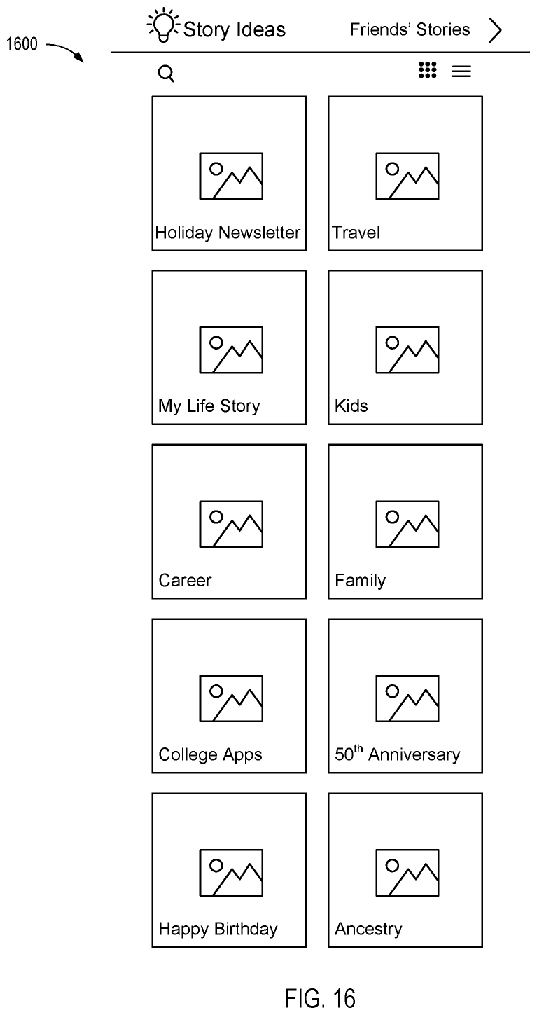

FIG. 16 illustrates an example GUI 1600 providing a user with additional examples, ideas, and/or templates for creating new stories, according to various embodiments. The system may select templates and/or ideas it believes will be more relevant. For example, templates and ideas may be specifically selected based on the user's age, likes and dislikes, and other identifying characteristics.

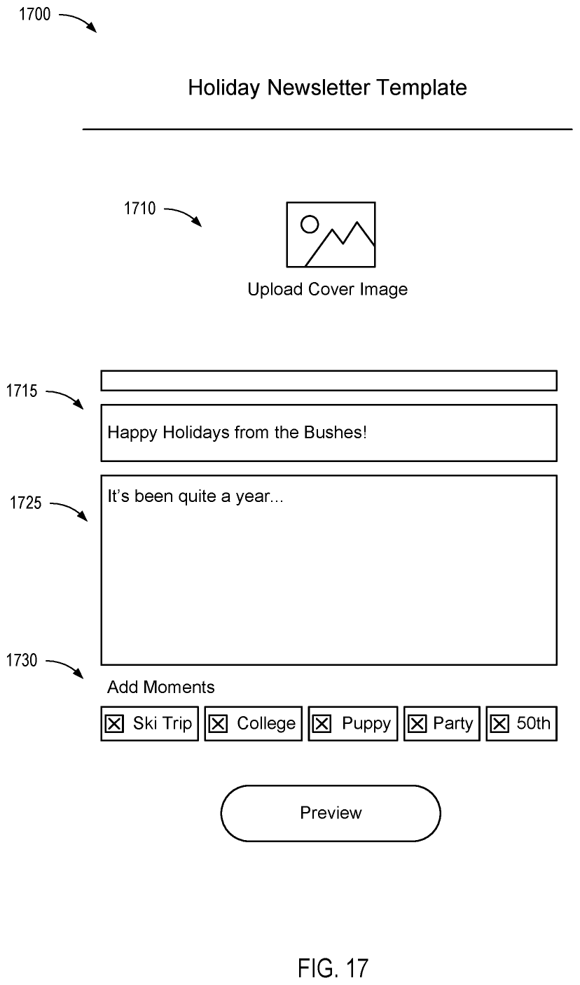

FIG. 17 illustrates an example GUI 1700 for generating a holiday newsletter using a template that allows for the incorporation of previously created stories and/or moments 1730, according to various embodiments. In some examples, when a moment 1730 is added, the cover image 1710, description 1715, and/or detailed description 1725 may be partially pre-populated.

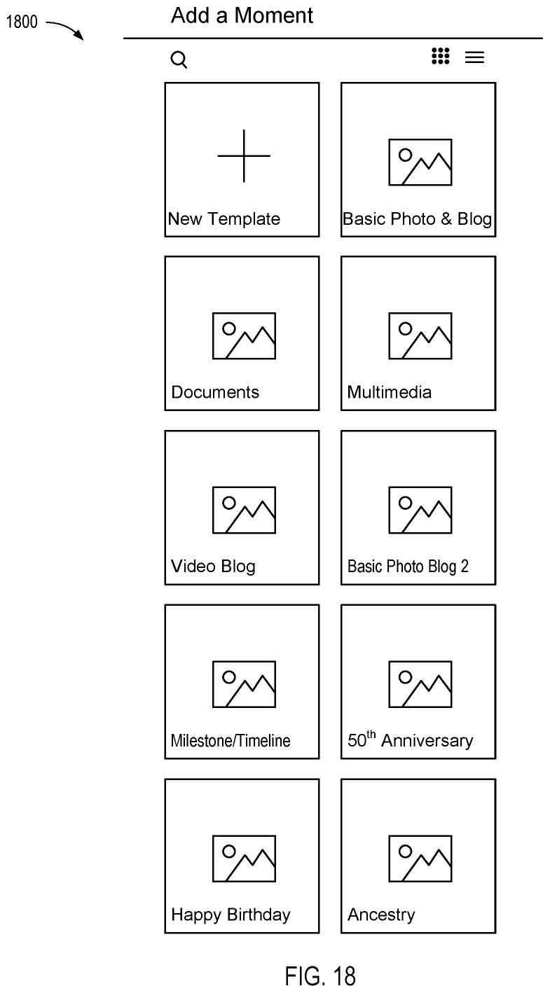

FIG. 18 illustrates an example of a GUI 1800 for creating a new moment content item from scratch or from a template, according to one embodiment. Example moments may be created based on documents, videos, special days, photos, etc.

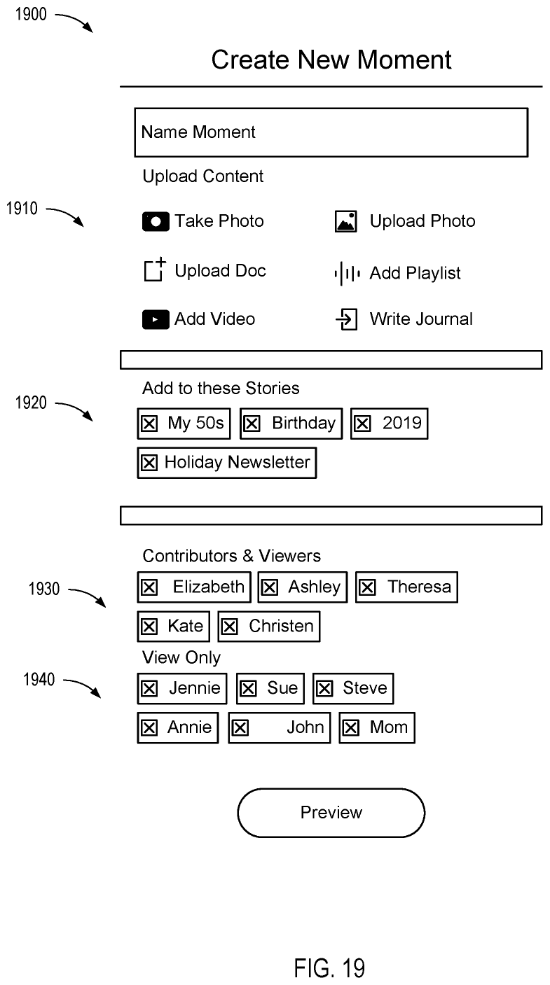

FIG. 19 illustrates an example of a GUI 1900 for creating a new moment and uploading and associating various digital content items 1910, such as photos, documents, videos, music, and/or journal entries. Similarly, previously created stories 1920 may be associated with the moment. As in other examples, the user may select who can view 1940 the content and who can also contribute 1930 to the content, according to various embodiments.

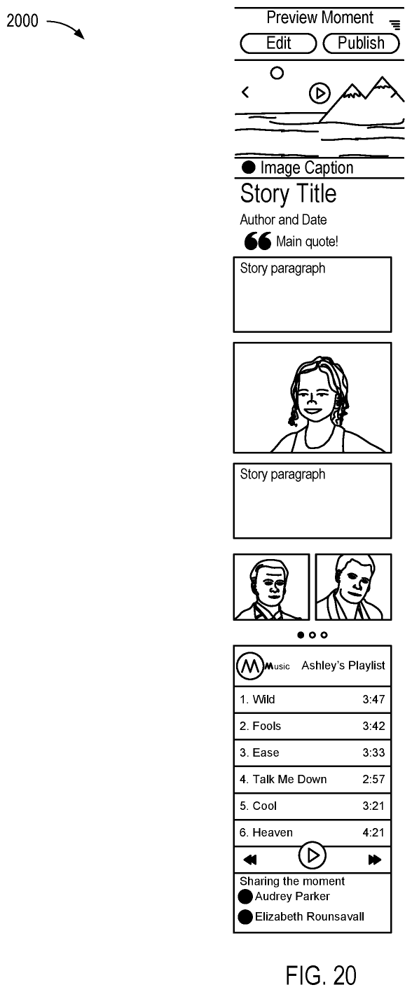

FIG. 20 illustrates an example of a GUI 2000 for previewing a moment content item prior to publishing, according to one embodiment.

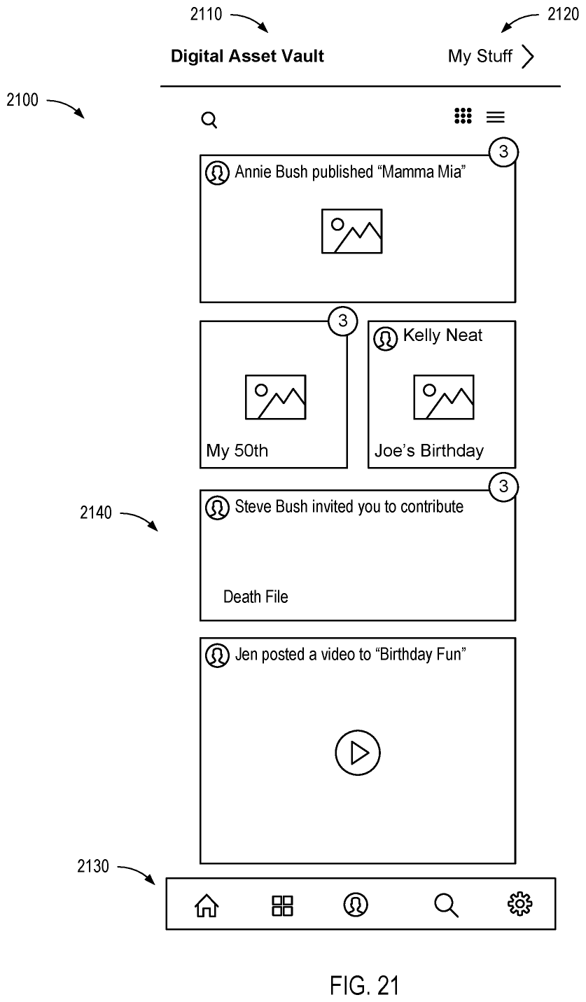

FIG. 21 illustrates an example of a possible home or landing page 2100 of a digital asset vault system, according to one embodiment. As illustrated, a particular company brand may be included to replace the generic name “digital asset vault” 2110. The user may navigate quickly to personal content items via the “My Stuff” link 2120. A toolbar 2130 may allow for general navigation within the app as well. The main body 2140 of the landing page 2100 may present the user with the latest updates from friends and family and/or provide reminders and nudges.

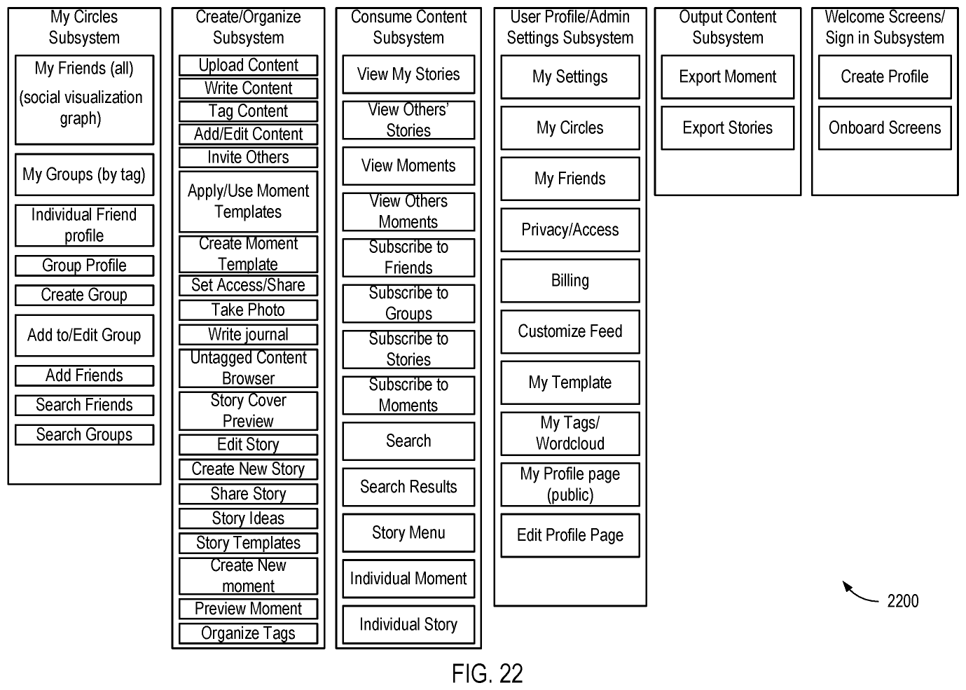

FIG. 22 illustrates a dense block diagram 2200 of the numerous functionalities available through various embodiments of the digital asset vault systems and associated methods described herein. The concepts are divided into six general categories of features. Specifically, a “My Circles” subsystem may allow for complete management of the circles and groups of friends. The next column is a content creation and organization subsystem listing numerous functionalities for creating, tagging, editing, inviting, sharing, previewing, and organizing content. A consume content subsystem may include various functionalities for viewing, sharing, subscribing, and searching the stories, moments, groups, and other content items in the system. Profile and management subsystems provide the user with complete administrative control of the account. In various embodiments, an output content subsystem allows moments and stories to be exported for inclusion on other social media platforms, for printing, for backup, and/or any other purpose. Welcome and sign-in subsystems may facilitate a seamless signup process and subsequent greetings with each return to the system.

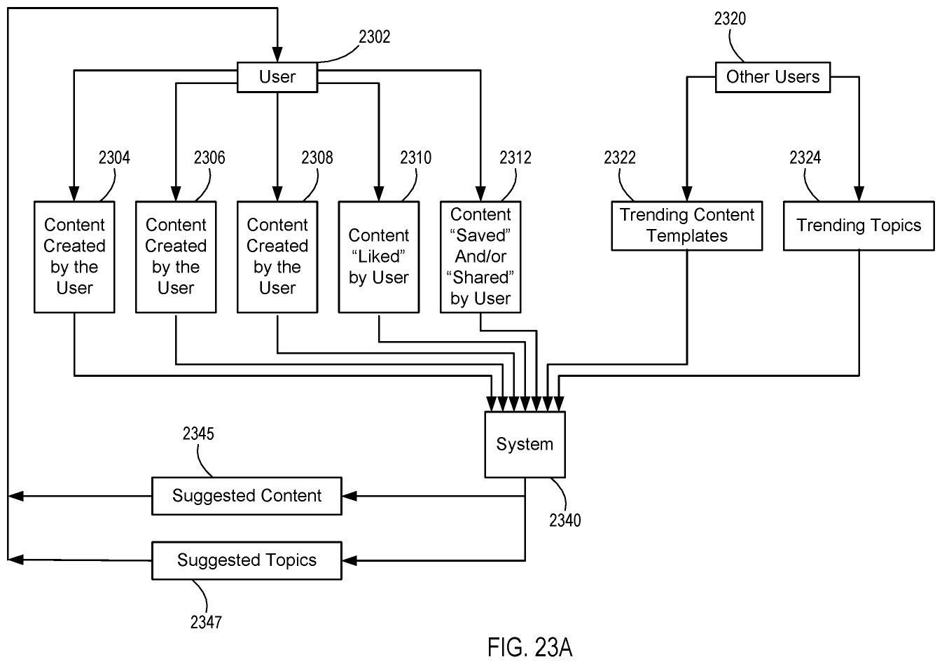

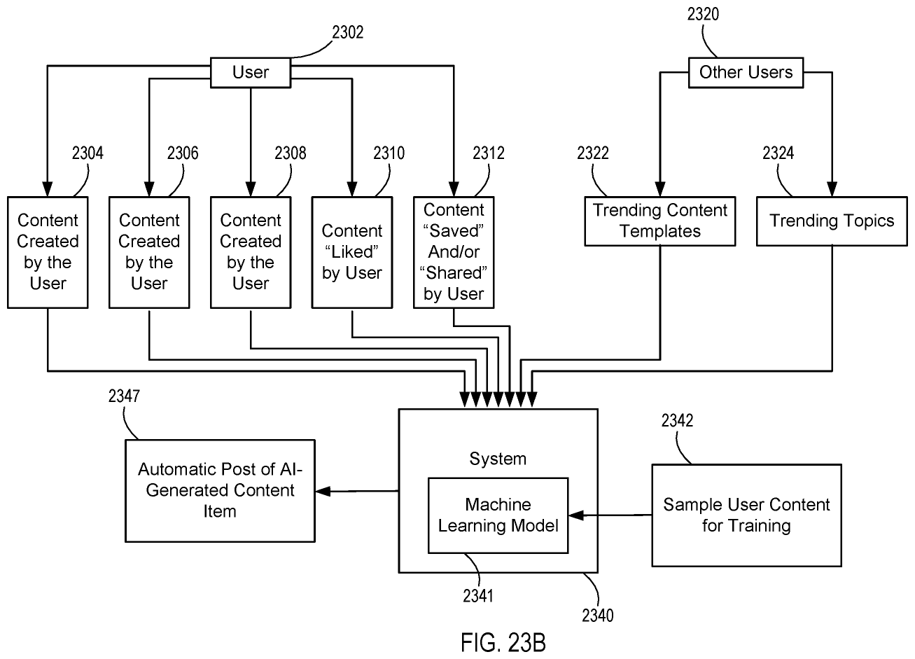

FIG. 23A illustrates an example block diagram of a system 2340 to generate smart prompts for a user, according to one embodiment. A user 2302 may generate content that is posted to websites or social media platforms, such as content items 2304, 2306, and 2308. The system 2340 may receive and analyze the user-created content items 2304-2308, content liked by the user 2310, and content that is saved and/or shared by the user 2312.

The system 2340 may also retrieve and/or analyze content created and/or shared by other users 2320 to identify trending content templates 2322 and/or trending topics 2324. The system 2340 may identify common interests, similar topics, and/or other subject-matter intersections of the user activity and the activity of third parties. The system 2340 may generate one or more content suggestions, such as suggested content 2345 or suggested topics 2347 for consideration by the user 2302. In some embodiments, the user 2302 may specify the frequency with which the content suggestions are presented to the user 2302.

FIG. 23B illustrates an example block diagram of the system 2340 similar to that described in conjunction with FIG. 23A, but with a machine learning model 2341 to automatically generate and post content to social media platforms 2347, according to one embodiment. As illustrated, the machine learning model 2341 may be trained using sample user content 2342 specifically adapted for training the machine learning model.

Additionally, or alternatively, the machine learning model 2341 may utilize the content created, liked, saved, and/or shared by the user 2304-2312 and/or content created by other users 2320 (including trending content templates 2322 and/or trending topics 2324). The machine learning model 2341 may be supervised or unsupervised to automatically post AI-generated content items 2347.

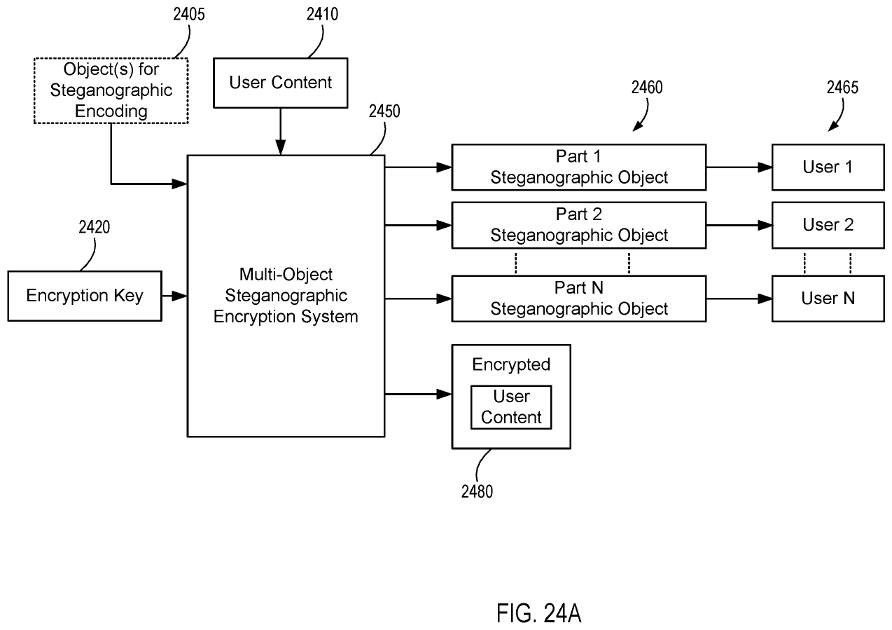

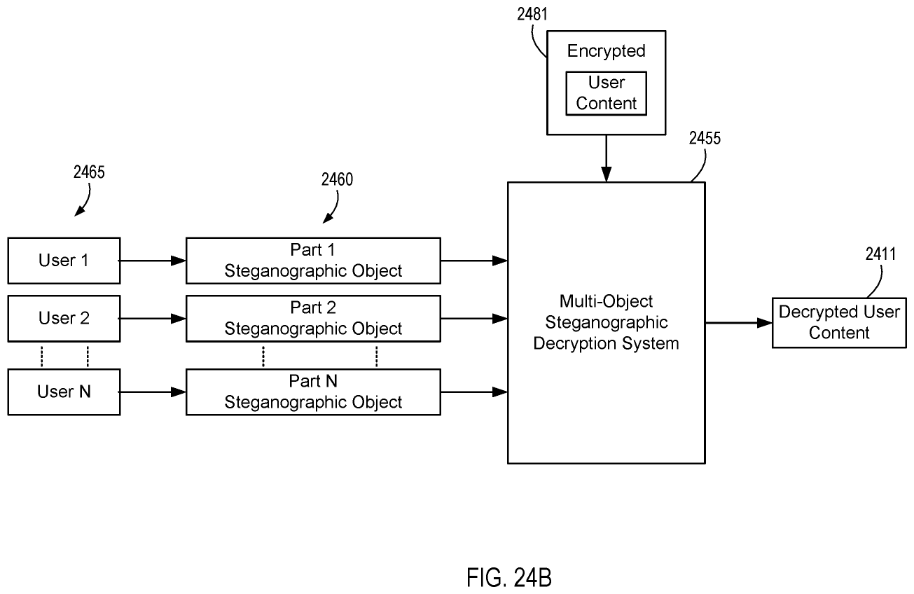

FIG. 24A illustrates an example of a multi-object steganographic encryption system 2450 that may, in some embodiments, be a subsystem of a larger system, according to various embodiments. As illustrated, the multi-object steganographic encryption system 2450 may receive user content 2410 for encryption using an encryption key 2420. The multi-object steganographic encryption system 2450 may encrypt the user content 2410 using the encryption key 2420 to generate encrypted user content 2480.

The multi-object steganographic encryption system 2450 may divide the encryption key 2420 into encryption key components (or otherwise generate encryption key components from which the original encryption key 2420 can be reconstructed). The multi-object steganographic encryption system 2450 may generate any number of steganographic objects 2460 that are each encoded with at least one of the encryption key components. Each steganographic object 2460 may be given to a different user 2465. Alternatively, some users 2465 may receive multiple steganographic objects 2460 or a single user may receive all of the steganographic objects 2460. As described herein, the encryption key 2420 may only be reconstructed if a minimum number of steganographic objects 2460 are presented to the multi-object steganographic decryption system 2450.

In some embodiments, the multi-object steganographic encryption system 2450 may generate random or arbitrary steganographic objects encoded with the encryption key components. In other embodiments, the user may optionally present or provide object(s) 2405 (e.g., images, audio files, video files, other multimedia files, etc.) to be steganographically encoded by the multi-object steganographic encryption system 2450 to generate the steganographic objects 2460.

FIG. 24B illustrates an example of a multi-object steganographic decryption system 2455, according to one embodiment. Multiple users 2465 may each present one or more steganographic objects 2460 to the multi-object steganographic decryption system 2455. Each of the steganographic objects 2460 may be encoded with one or more encryption key components. The multi-object steganographic decryption system 2455 decodes the steganographic objects 2460 to extract the encryption key components.

The multi-object steganographic decryption system 2455 uses the encryption key components to generate the encryption key, as described herein (e.g., using inverse mathematical operations, inverse functions, Boolean operations, and/or the like). The multi-object steganographic decryption system 2455 decrypts the encrypted user content 2481 using the encryption key to generate the decrypted user content 2411

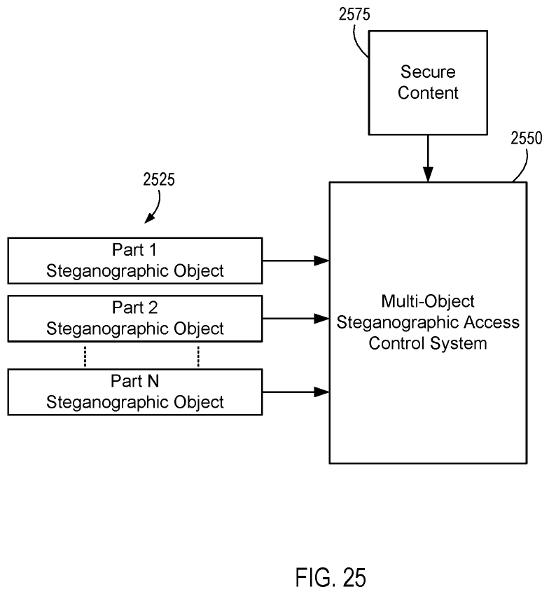

FIG. 25 illustrates an example block diagram of a multi-object steganographic access control system 2550, according to one embodiment. The multi-object steganographic access control system 2550 may include a computing system with a processor and memory to execute instructions. The instructions may cause the system to receive a plurality of steganographic objects 2525. For example, one or more users may upload the steganographic objects 2525 to the multi-object steganographic access control system 2550. In some instances, a user may request access to specific secure content 2575 within a secure data storage. In other embodiments, the secure content 2575 within the secure data storage may be implied, identified, or encoded within one or more of the uploaded steganographic objects 2525.

Each of the steganographic objects 2525 may be encoded with one or more access credentials or access credential components. The multi-object steganographic access control system 2550 may require the presentation of multiple access credential components encoded within the multiple steganographic objects 2525 before granting the presenting user(s) access to the secure content 2575 within the secure data storage.

For example, a content item may be stored within a secure data storage and associated with five unique access credential components. The multi-object steganographic access control system 2550 may encode each of the five unique access credential components within a unique steganographic object 2525. The five steganographic objects 2525 may be distributed to, for example, five different users. The secure content 2575 cannot be accessed unless all five steganographic objects 2525 are presented to the multi-object steganographic access control system 2550. In other embodiments, the content item may be secured within the secure data storage with access rights specifying that access should be granted upon presentation of any three of the five access credential components encoded within the steganographic objects 2525.

According to the access rights of a particular secured content item 2575, the multi-object steganographic access control system 2550 grants access upon successful validation of the requisite access credential components. Similarly, the multi-object steganographic access control system 2550 denies access to the secure content item 2575 upon failure to validate the access credential components.

The above description provides numerous specific details for a thorough understanding of the embodiments described herein. However, those of skill in the art will recognize that one or more of the specific details may be omitted, modified, and/or replaced by a similar process or system. The scope of the present disclosure should be determined to encompass at least the claims presented below.

What is claimed:

1. A system, comprising:
a processor;
a memory; and
a multi-object steganographic encryption subsystem to:
receive a user content item;
encrypt the user content item using an encryption key to generate an encrypted user content item;
generate a plurality of encryption key components that can be used to reconstruct the encryption key; and
generate a plurality of steganographic objects that are each steganographically encoded with one of the encryption key components; and
a multi-object steganographic decryption system to:
receive the encrypted content item;
receive at least some of the plurality of steganographic objects encoded with the encryption key components;
extract the encryption key components from the received steganographic objects;
reconstruct the encryption key using the extracted encryption key components; and
decrypt the encrypted content item using the extracted encryption key to generate a decrypted content item.

2. The system of claim 1, wherein the user content item comprises at least one of an image, a data file, and a multimedia file.

3. The system of claim 1, wherein each of the encryption key components is generated as a mathematical operation of the encryption key.

4. The system of claim 1, wherein a first encryption key component comprises a random number and a second encryption key component comprises a mathematical operation of the first encryption key component and the encryption key, such that the encryption key can be reconstructed via a reverse mathematical operation of the first and second encryption key components.

5. The system of claim 4, wherein the mathematical operation comprises a Boolean logic XOR operation.

6. An encryption system, comprising:
a processor;
a memory; and
a multi-object steganographic encryption subsystem to:
receive a user content item;
encrypt the user content item using an encryption key to generate an encrypted user content item;
generate a plurality of encryption key components that can be used to reconstruct the encryption key; and
generate a plurality of steganographic objects that are each steganographically encoded with one of the encryption key components.

7. The system of claim 6, wherein the multi-object steganographic encryption subsystem is configured to generate at least three encryption key components and at least three steganographic objects, each of which is encoded with one of the three encryption key components.

8. The system of claim 7, wherein the multi-object steganographic encryption subsystem is configured to generate the encryption key components such that any two encryption key components can be used to reconstruct the encryption key.

9. The system of claim 7, wherein the multi-object steganographic encryption subsystem is configured to generate the encryption key components such that all the encryption key components are required to reconstruct the encryption key.

10. The system of claim 6, wherein the multi-object steganographic encryption subsystem is further configured to receive, from a user, a requested number of steganographic objects.

11. The system of claim 6, wherein the multi-object steganographic encryption subsystem is further configured to receive at least one multimedia file from a user for steganographic encoding, and wherein the multi-object steganographic encryption subsystem uses the at least one received multimedia file to generate the plurality of steganographic objects.

12. An access control system, comprising:
a processor;
a memory; and
a multi-object steganographic access control system to:
receive a plurality of steganographic objects uploaded from a client computing device, wherein each of the steganographic objects is encoded with an access credential component;
extract the access credential components from the plurality of received steganographic objects;
validate the extracted access credential components;
grant access to a secure content item stored in a secure data storage upon successful validation of at least two access credential components; and
deny access to the secure content item upon failure to validate at least two access credential components.

13. The system of claim 12, wherein the multi-object steganographic access control system is further configured to:
receive a request from the client computing device to access the secure content item.

14. The system of claim 12, wherein the multi-object steganographic access control system is further configured to:
identify the secure content item based on the extracted access credential components.

15. A system, comprising:
a processor; and
a non-transitory computer-readable medium with instructions stored thereon that, when executed by the processor, cause the system to implement operations to:
identify a plurality of trending topics on at least one social media platform;
analyze activity of a user on the at least one social media platform, including at least one of:
content items posted by the user on the at least one social media platform, and
third-party content that is a least one of liked, shared, or saved by the user on the at least one social media platform;
identify an intersection of the plurality of trending topics and the user activity on the at least one social media platform; and
generate a content suggestion that includes at least one of:
a suggested topic of a content item for the user to create and post on a target social media platform, and
a suggested third-party content item for the user to share on the target social media platform.

16. The system of claim 15, wherein the content suggestion comprises a suggested topic and a suggested template for the user to use when creating a content item.

17. A system, comprising:
a processor; and
a non-transitory computer-readable medium with instructions stored thereon that, when executed by the processor, cause the system to implement operations to:
train a machine learning model with sample user-created content items to automatically generate new content items for posting on a social media platform;
analyze digital activities of a user, including at least one of:
available images,
travel records,
content items posted by the user on the social media platform, and
third-party content that is a least one of liked, shared, or saved by
the user on the social media platform;
generate, via the trained machine learning model, an autogenerated content item for automatic posting on the social media platform; and
post the autogenerated content item on the social media platform on behalf of the user without any user interaction.

18. The system of claim 17, wherein the instructions, when executed by the processor, are further configured to cause the systems to implement operations to:
identify trending topics on the social media platform; and
identify an intersection of the trending topics and the digital activities of the user,
wherein the autogenerated content item for automatic posting on the social media platform is based on the digital activities identified as intersecting with the trending topics on the social media platform.

19. The system of claim 17, wherein the instructions, when executed by the processor, are further configured to cause the systems to implement operations to:
request user-review of the autogenerated content item posted on the social media platform on behalf of the user; and
update the machine learning model based on feedback provided by the user in response to the request for user review.

20. The system of claim 17, wherein the autogenerated content item comprises an image and a written description of the image.
